(19) United States
(12) Patent Application Publication
(10) Pub. No.: US 2012/0052463 A1
(43) Pub. Date: Mar. 1, 2012

(54) Device and Method for Capturing Dental Records

(76) Inventor: Alan Pollet, East Hanover, NJ (US)

(21) Appl. No.: 12/861,958

(22) Filed: Aug. 24, 2010

(51) Int. Cl. A61C 13/225; A61C 13/103

(52) U.S. Cl. 433/172; 433/215

(57) ABSTRACT

The present invention relates to a device and method for making dental records, particularly bite registrations for confirming the location, size, height and/or orientation of dental implants. More specifically, the present invention relates to a device and method for making a bite record for restoring teeth using internally configured dental implants. The device may comprise a sterile, plastic, press-fit component, made in varying lengths and in appropriate diameters to work with varying implant platform dimensions. The device may be a single piece component that does not require screw retention.

### FIELD OF INVENTION

The present invention generally relates to the making of dental records, particularly bite registrations, for establishing and confirming the interarch relationship of dental implants to either opposing implants, a prosthesis or natural teeth. More specifically, the present invention relates to a device and method for making bite records, where internally configured implants are being used to support prosthetic tooth replacement.

### BACKGROUND OF THE INVENTION

To replace missing teeth, dentists can surgically place fixtures or implants, into the bone of a patient, attaching prosthetic teeth with supporting abutments to replace either single or multiple missing teeth. Crowns may be either screw or cement retained onto these supporting abutments. In recent years, there has been a trend away from external, to internally configured implants. Internally configured designs appear to be more stable, have less risk of screw breakage, and are capable of withstanding more force load. External hex implants are more prone to problems with screw loosening or breakage.

After surgery, patients are typically given a number of months to heal, though in some instances, implants are immediately loaded with provisional crowns. The healing period will permit the implant to biologically and mechanically integrate with the maxillary or mandibular bone. This bio-integration is critical to the long-term success of the restoration. Successful integration ensures resistance to the repeated mechanical forces of mastication and sometimes parafunction (clenching or bruxing).

At the end of the healing period, usually 4-6 months, healing is considered complete. At this time, the healing screw is removed, a transfer coping screwed into the implant, and a dental impression is made to capture the precise position and relationship of the implant to the soft tissues, adjacent structures and the rest of the arch form. An additional impression is made of the opposing arch. It is important that these impressions be highly accurate and detailed, so that the resulting models accurately reflect the intraoral relationships. It is also critical that an accurate bite registration be fabricated, relating both arches for mounting on an articulator, a device that will help reproduce contact patterns and a range of jaw movements. This will help minimize adjustments in the mouth and help create a final result that will be both functional and esthetic, one that is biocompatible, not inflicting any harm to the implants, muscles, or tempero-mandibular joint.

In a properly equilibrated dentition, when restoring a single tooth or teeth surrounded by healthy natural teeth, casts might simply be articulated to a habitual position. However, when replacing a quadrant or full arch of teeth, making a bite registration becomes an essential part of the process. Without an existing component to accomplish this, often the laboratory will have to fabricate a screw retained device that can be used to make the registration. This is accomplished at a separate patient appointment, adding both cost and time.

There appears to be a void in the present armamentarium of the implant companies in offering a bite registration component. It is therefore, the object of this invention to produce a simple device to aid in capturing a bite registration. This would not require laboratory involvement or an additional appointment. This would be a press fit, requiring no screws, available in a variety of lengths, and diameters to accommodate varying platform dimensions of the implants. It would be compatible with a wide variety of materials that are currently available and used in fabricating bite registrations.

### SUMMARY OF THE INVENTION

A dental coping having a head portion having a shape configured to approximate an occlusal or incisal biting surface and a post portion configured to reversibly press-fit into a bore of a dental implant for receiving a dental abutment. The post portion extends form the end of the body opposite said the head portion. The dental coping may also comprise an elongated body extending from the head portion. The head portion and the elongated body together are configured to approximate the height of a tooth from a patient. In one embodiment, when the coping is press-fitted onto said dental implant, a distance between the head portion and opposing bite surface from the patient approximates an anatomical occlusal or incisal distance of the patient. Preferably, the coping does not touch the opposing bite surface of the patient. In another embodiment, when the coping is press-fitted onto said dental implant, the distance between the head portion and the opposing bite surface from the patient may approximate a combined distance of an anatomical occlusal or incisal distance of the patient and a thickness of a bite registration material. For example, the thickness of the bite registration material may be at least 2 mm.

A method for obtaining a bite registration of a patient having a dental implant for supporting prosthesis is also provided. The method includes a step of (a) reversibly attaching a dental coping to the implant by pressing the coping into a bore of the implant for receiving a dental abutment. The coping has a head portion have a shape configured to approximate an occlusal or incisal biting surface, and an elongated body extending from the head portion. The head portion and the elongated body together are configured to approximate the height of a tooth from a patient. In certain embodiments, step (a) may include adjusting a height of the dental coping such that when the device is attached onto the dental implant, a distance between the head portion and opposing bite surface from the patient approximates an anatomical occlusal or incisal distance of the patient. The method further includes the steps of (b) applying a registration material to an occlusal or incisal space between the dental coping and opposing bite surface from the patient, (c) causing the patient to bite on the registration material, and (d) removing said registration material from said patient.

A method for indexing a dental implant of a patient is also provided. The method includes a step of (a) reversibly attaching a dental coping to said implant by pressing said coping into a bore of said implant for receiving a dental abutment. The coping has a head portion have a shape configured to approximate an occlusal or incisal biting surface, and an elongated body extending from the head portion. The head portion and the elongated body together are configured to approximate the height of a tooth from a patient. In certain embodiments, step (a) may include adjusting a height of the dental coping such that when the device is attached onto the dental implant, a distance between the head portion and opposing bite surface from the patient approximates an anatomical occlusal or incisal distance of the patient. The method further includes the steps of (b) applying a registration material to said dental coping, (c) aligning a dental surgical guard to said patient's teeth, (d) continuously applying a pressure against said dental surgical guard towards said registration material until said hardens, and (e) removing said registration material from said patient.

These and other aspects of the invention will become apparent to those skilled in the art after a reading of the following detailed description of the invention, including the figures and appended claims.

### BRIEF DESCRIPTION OF THE FIGURES

FIG. 1A shows a side-view of an exemplary embodiment of the inventive device for making a bite record according to the present invention.

FIG. 1B shows a top-view of the exemplary embodiment of the inventive device of FIG. 1A.

FIG. 2 shows a side-view of the exemplary embodiment of the inventive device of FIG. 1A fitted into a dental implant.

FIG. 3 shows use of the exemplary embodiment of the inventive device of FIG. 1A in obtaining a bite record of a patient's teeth.

FIG. 4 shows an alternative use of the exemplary embodiment of the inventive device of FIG. 1A.

FIG. 5A shows an alternative embodiment of the inventive device of FIG. 1A.

FIG. 5B shows the embodiment of the inventive device of FIG. 5A in an extended configuration.

### DETAILED DESCRIPTION

After surgery, patients are typically given a number of months to heal, though in some instances, implants are immediately loaded with provisional crowns. The healing period will permit the implant to biologically and mechanically integrate with the maxillary or mandibular bone. This bio-integration is critical to the long-term success of the restoration. Successful integration ensures resistance to the repeated mechanical forces of mastication and sometimes parafunction (clenching or bruxing).

At the end of the healing period, usually 4-6 months, healing is considered complete. At this time, the healing screw is removed, a transfer coping screwed into the implant, and a dental impression is made to capture the precise position and relationship of the implant to the soft tissues, adjacent structures and the rest of the arch form. An additional impression is made of the opposing arch. It is important that these impressions be highly accurate and detailed, so that the resulting models accurately reflect the intraoral relationships. It is also critical that an accurate bite registration be fabricated, relating both arches for mounting on an articulator, a device that will help reproduce contact patterns and a range of jaw movements. This will help minimize adjustments in the mouth and help create a final result that will be both functional and esthetic, one that is biocompatible, not inflicting any harm to the implants, muscles, or tempero-mandibular joint.

In a properly equilibrated dentition, when restoring a single tooth or teeth surrounded by healthy natural teeth, casts might simply be articulated to a habitual position. However, when replacing a quadrant or full arch of teeth, making a bite registration becomes an essential part of the process. Without an existing component to accomplish this, often the laboratory will have to fabricate a screw retained device that can be used to make the registration. This is accomplished at a separate patient appointment, adding both cost and time.

There appears to be a void in the present armamentarium of the implant companies in offering a bite registration component. It is therefore, the object of this invention to produce a simple device to aid in capturing a bite registration. This would not require laboratory involvement or an additional appointment. This would be a press fit, requiring no screws, available in a variety of lengths, and diameters to accommodate varying platform dimensions of the implants. It would be compatible with a wide variety of materials that are currently available and used in fabricating bite registrations.

With adequate stability, the component might also be used as a transfer component to index the position of an implant at the time of surgical placement. This can be used to fabricate a provisional restoration during the healing period.

Splinting of multiple components on adjacent implants, with a rigid non-distorting material, could also provide an index to verify the accuracy of castings at a later time. Implant analogs can be attached and a base of stone poured to fabricate the index.

The present invention relates to a device and method for making an incisal or occlusal bite record for restoring teeth using internally configured dental implants. The device comprises a press-fit component, such as, for example, a coping, which may have any suitable dimensions, including varying lengths, for fitting into a gap created by the removal of a natural tooth. It may be fitted into an opening on an implant that has been surgically placed into the bone tissue, e.g., jaw bone, of a patient. For example, the device or coping may be attached to the implant via a stable, frictional fit without screws or any screw retentive mechanisms. Preferably, the device may comprise a sterile, plastic, press-fit component. In one embodiment, the device may comprise a head portion having a shape configured to approximate occlusal or incisal biting surface, preferably a flattened occlusal or incisal biting surface, and a post portion configured to reversibly press-fit into a bore of a dental implant that is designed to later receive a dental abutment and/or crown.

It is believed that the inventive device is simple to use and is stable enough to not require any screw retentive mechanisms (e.g., screws), as most other current implant components require. The absence of screw retention mechanisms makes insertion of the device a more facile and quicker process. Moreover, the inventive device or coping can be used with any configuration of teeth. In particular, each device or coping corresponds to a tooth of the patient and may be individually used or placed into the patient's mouth to accommodate various different types and shapes of bite configurations. For example, the inventive device may accommodate numerous sizes and configurations, including different widths (e.g., different implant platform sizes), different heights, different distances between the upper and lower dental arches, placement of implants that are not well aligned with each other, or are not parallel to each other. Specifically, each device or coping may comprise a single, continuous structure corresponding to a tooth of the patient. Preferably, the head portion of the device has a flattened portion to support any common bite registration material. The material could remain detachable or be bonded directly to the inventive device or copings.

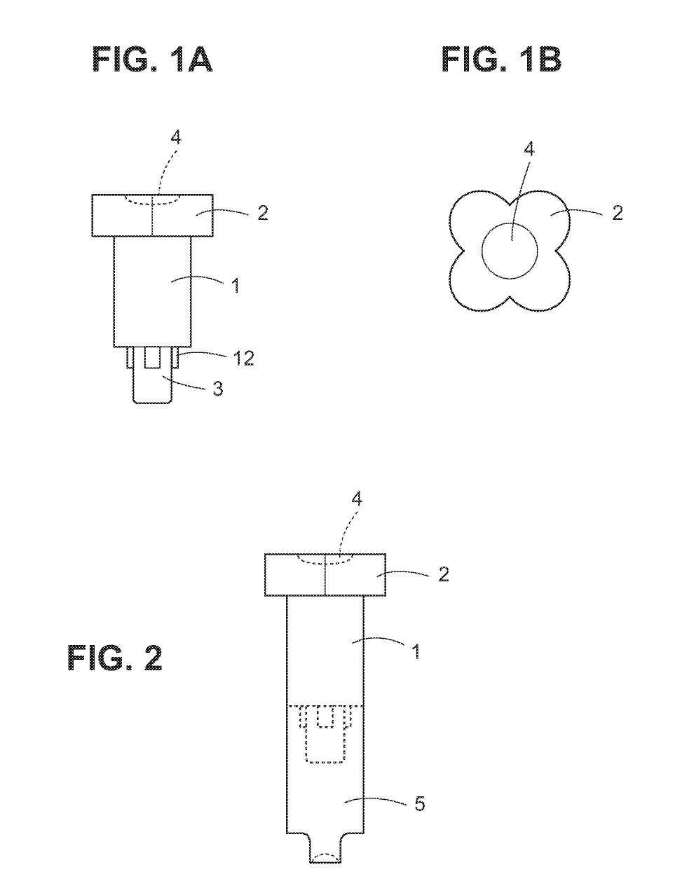

FIGS. 1A and 1B, show a side-view and a top-view, respectively, of a specific embodiment of the device according to the present invention. The device as shown in FIG. 1A comprises an elongated body portion 1 having any suitable size and shape for serving as a placeholder for a removed tooth. For example, the body portion 1 may be elongated vertically and having a horizontal cross-sectional shape of a circle, oval, triangle, square, pentagon, hexagon, or any other regular or irregular shapes. In one exemplary embodiment, varying lengths of the body portion 1 may also accommodate differing inter-arch distances. Preferably, the body portion 1 has a circular horizontal cross-sectional shape. More preferably, the body portion 1 has a substantially cylindrical or cylindrical shape. For example, the shape of the body portion 1 can be made with a straight or wider emergence profile, to accommodate soft tissue contours. Moreover, in this exemplary embodiment, the diameter of the post portion 3, which is the end that interfaces with the implant wuld correspond to the differing implant platform sizes (e.g., narrow, regular or wide). Preferably, the diameter of the post portion 3 has a diameter that corresponds or substantially corresponds to the size of the platform in commercially used dental implants

Where the body portion 1 has a substantially cylindrical or cylindrical shape, the diameter and/or length of the body portion 1 may be of any suitable size to temporarily replace a removed tooth. In particular, the body portion 1 may have a diameter and/or length that is at least 5, 7, 10, or 13 mm. Specifically, the diameter of the body portion 1 is equal to or slightly (e.g., about 0.1 to about 0.2 mm) greater than the size of the platform in commercially used dental implants. More preferably, the diameter of the body portion 1 corresponds to the size of the platform of the implant to which it is fitted. The device may be colored to provide color-coding for each diameter size corresponding to a platform size. The color-coding allows a dentist to easily ascertain the size of the device without measuring the device.

The body portion 1 can be of any suitable height for fitting within the mouth of a patient, fitting onto a dental implant 5, and/or allowing a patient's upper and lower teeth to come together without interference when the mouth is closed. Preferably, the body portion 1 has a height that accommodates the distance between the upper and lower teeth or the inter-arch distance, at or near the implant site. In certain embodiments the body portion 1 may have a height of at least 5 mm, at least 7 mm or at least 10 mm. In one particular embodiment, the device may be a coping formed from a plastic material where the head thickness may be reduced or modified with a bur, to be certain that there is adequate clearance for the bite registration material. The device or coping of the present invention may be suitable for use with both centric and habitual bite registration techniques.

The device may also comprise a head portion 2 attached to the body portion 1 at the terminal end away from the implant 5. Generally, the head portion 2 may have a substantially flat shape to receive the registration material. For example, the height may be less than the width at the widest point of the head portion 2, or a diameter of the head portion 2. Preferably, the height of the device should allow for some reduction to accommodate adequate space and thickness of the registration material. In some embodiments, the head portion 2 may have a symmetrical or asymmetrical shape and may be suitably shaped to permit placement of the device onto a dental implant 5, for example, with simple finger pressure, and suitably fitted between natural teeth and/or adjacent implants. For example, the head portion 2 may have an irregular shape, for example a shape that resembles an upper portion, e.g., occlusal or incisal cusp, of a tooth. In particular, the head portion 2 may have a shape, when viewed from above, that resembles a clover-leaf, such as for example, the top view shown in FIG. 1B. If the head portion 2 has an asymmetrical shape or any other shape that provides an orientation of the device, then the device provides easy means for a dentist to index and identify the orientation of a patient's bite registration formed using the invention device. The irregular shape would provide easier seating of the device or copings the present invention on adjacent implants that are placed in close proximity to each other. A simple vertical mid-facial line of permanent marker could also be used to help orient the coping on an analog working model for dental reconstruction.

In some embodiments, the surface at the external terminal end (i.e., external to biologic tissue) of the head portion 2 is irregular and comprises a depression 4 (e.g., dimple) therein. The depression 4 may be located at the center of the surface of the external terminal end of the head portion 2. In one particular embodiment, the head portion 2 is co-axial with the body portion 1 about a vertical axis, and the depression 4 is located about the vertical axis on the surface at the external terminal end of the head portion 2. The depression 4 may be symmetrical or asymmetrical. The depression 4 helps to index and identify the orientation of a patient's removable bite registration formed using the invention device based on the orientation of the depression 4. Additionally, the head portion 2 may have sufficient thickness and/or the depression 4 may have sufficient depth to allow the dentist to remove a small portion of the external terminal end to configure and adjust the height of the device to a patient's anatomical bite configurations and size. For example, if more inter-occlusal space is needed between the device and the counterpart teeth 9 (e.g., if the device is placed into the lower teeth, the counterpart teeth are those teeth from the upper dental arch that touch the device when the mouth is closed, and if the device is placed into the upper teeth, the counterpart teeth are those teeth from the lower dental arch that touch the device when the mouth is closed), the head portion 2 may be slightly reduced to accommodate the configuration and spacing of the patient's upper and lower teeth.

The device may further comprise a post portion 3 attached to the body portion 1 at the end away from the head portion 2 for engaging and/or fitting into an orifice or a bore of a dental implant 5. The orifice or bore may be suitably shaped for receiving a dental abutment therein. The orifice or bore may have any suitable shape, including for example, hexagonal, conical, or cylindrical shapes. Each dental manufacturer may utilize a differently shaped orifice or bore for receiving a dental abutment therein. It is contemplated that the inventive device of the present invention may be suitably shaped to be utilized with any dental implant having an orifice or bore with an internal configuration to receive an abutment, including, for example, abutments from implant systems manufactured by Biomet 3i and Nobel Biocare. It is believed that the inventive device of the present invention may also be suitably shaped to be utilized with abutments form implant systems manufactured by Astra Tech, BioHorizons, Dentsply Friadent, Keystone Dental, Straumann, Sybron Implant Solutions, and Zimmer Dental. In certain embodiments, the orifice or bore may comprise a bore having internal keys, grooves or channels configured to prevent rotation of the device or coping.

Preferably, the post portion 3 is suitably sized and shaped to completely and securely fit into the orifice or bore of the dental implant 5. The post portion 3 may have any elongated shape. For example, the post portion 3 may be elongated vertically and having a horizontal cross-sectional shape of a circle, oval, triangle, square, pentagon, hexagon, or any other regular or irregular shapes, which preferably corresponds to the particular implant of the patient. In a preferred embodiment, the post portion 3 has a smooth outer wall that does not engage any screw threads that might be present, because screw threads may interfere with seating and removal of the post portion 3 from the implant. The post portion 3 may have a substantially circular or circular horizontal cross-sectional shape. In particular, the post portion 3 may be suitably sized and shaped to press-fit into an orifice or bore of the dental implant 5. Specifically, the post portion 3 may have a shape substantially similar or corresponding to the shape of a terminal end of any suitable dental abutment for interfacing with an implant, including, for example, abutments from implant systems manufactured by Biomet 3i and Nobel Biocare. In a particularly preferred embodiment, the post portion 3 is co-axial with the body portion 2 along a vertical axis. Preferably, the post portion 3 and head portion 2 may be manufactured as a contiguous one piece component.

In another embodiment, the post portion 3 further comprises protrusions 12 configured to engage grooves, channels and/or keyways around the orifice of the implant 5. These protrusions 12, engage the grooves and/or channels of the implant 5 and allow the device to be fixed in one particular orientation and prevent the device from rotating about its vertical axis when inserted into the orifice or bore of the dental implant 5. This also provides further stability during use. Preferably, these protrusions do not engage any internal threads of the implant 5.

FIG. 2 shows a side-view of the exemplary embodiment of the inventive device of FIG. 1A fitted into a dental implant 5. The dental implant 5 may comprise any suitable implant or device used to secure a prosthetic tooth in a patient's mouth. Preferably, the dental implant 5 may comprise an internally configured fixture that may be surgically placed into the patient's jaw bone. The implant may serve as an artificial root for securing a prosthetic tooth. In the particular embodiment shown in FIG. 2, the post portion 3, including protrusions 12, may be completely inserted into an orifice at the external terminal end of the implant 5. Preferably, the post portion 3 provides a flush fit into the orifice of the implant 5. In certain embodiments, the post portion 3, completely fills the orifice at the external terminal end of the implant 5. In a preferred embodiment, the orifice or bore has a complementary shape to the post portion 3 of the inventive device.

The inventive device may be formed from any suitable material. In particular, the material is sterile and suitable for use in dentistry. Preferably, the material is a biocompatible material. In some embodiments, the device may be formed from a plastic material, preferably a non-malleable or rigid plastic material. The plastic material is typically a polymeric material. In particular, the device may comprise thermoplastic and/or thermosetting polymers. Suitable materials for the inventive device include, for example, polypropylene, polystyrene, acrylonitrile butadiene styrene, polyethylene terephthalate, polyester, polyamides, polyvinyl chloride, polyurethanes, polycarbonate, polyethylene, polylactic acid, etc.

In one particular embodiment of the present invention a kit comprising a plurality of the inventive coping having different heights is provided. For example, the kit may comprise a compartmentalized box having a plurality of rows and columns for holding the inventive copings. Each row of copings may correspond to a particular platform size with which the inventive coping is compatible and each column may represent a height of said coping. In one specific embodiment, the box may comprise 3 rows of differently sized inventive copings corresponding to narrow, regular and wide platform sizes. Each row of copings may comprise 4 different copings having different heights, such as, a height of 5, 8, 11 and 14 mm. It is contemplated that the kit may comprises any assortment of sizes and height of the inventive copings.

Alternatively, the device may be used to provide a rigid structural support to the soft tissue surrounding the implant site. The device may be attached, e.g., press-fitted, onto a dental implant 5 surgically placed into the bone of a patient. For example, the device may be attached to an internal implant surgically placed into the roots of the teeth or the bone of the patient to temporarily support the soft tissue and prevent collapse of the soft tissue around the implant, particularly where the implant is a deeply placed fixture. The device may provide a rigid structural support for the soft tissue surrounding the implant site. For example, the inventive device is particularly useful as a rigid structural support for the support tissue after the healing screw is removed from the implant. Additionally, the device may be attached to the internal implant to temporarily maintain patency of the soft gums, particularly the soft tissue sulcus around the implant site, before a permanent prosthesis is placed or while other treatment is being performed during a given appointment, without the use of a screw or any screwed retention mechanism for holding the device in place. In situations where there is considerable thickness of soft tissue over the implant that has not epithelialized, the inventive device could maintain patency of the sulcus while other treatment is being performed during a given appointment, without the use of a screw or any screwed retention mechanism for holding the device in place. The inventive device may be particularly useful in a patient in need of multiple fixtures, as an interim component to maintain soft tissue form. In an already shaped sulcus, the device may be placed into the sulcus and further adjusted and customized by applying a light or self-curing resin to fill, preferably completely fill, the sulcus.

In another embodiment, the device may also be used to identify and/or index an implant's orientation and/or position along the dental arch of a patient. For example, a bite registration made using the inventive device may provide a distinctive impression in the bite registration at the location of the device to allow a dentist to identify the position of the implant along a patient's dental arch. The inventive device may also function as a verification jig for assessing the relative position of the implants to each other and to the natural teeth remaining in the patients' mouth, which can provide valuable information regarding the patient's dentition for molding a working cast for the making of prosthetic teeth.

The device may also serve as a transfer component to index the position of the implant along a model of a dental arch, such as, for example, a dental surgical guide. Typically, the dental surgical guide has a shape corresponding to the shape of the patient's teeth prior to surgery, such as, for example, removal of diseased teeth and insertion of dental implants. The dental surgical guide may have a shape complementary to an impression of the patient's teeth prior to surgery. The dental surgical guide may be formed by making complementary impression of a cast formed from an impression of the patient's teeth obtained prior to surgery. The location of the implant along the dental surgical guide may be indexed and identified using the inventive device. The position on the dental surgical guide may provide information regarding the removed tooth and location of the implant for the construction of immediate provisional crowns as temporary replacements for the tooth that is to be replaced by prosthesis.

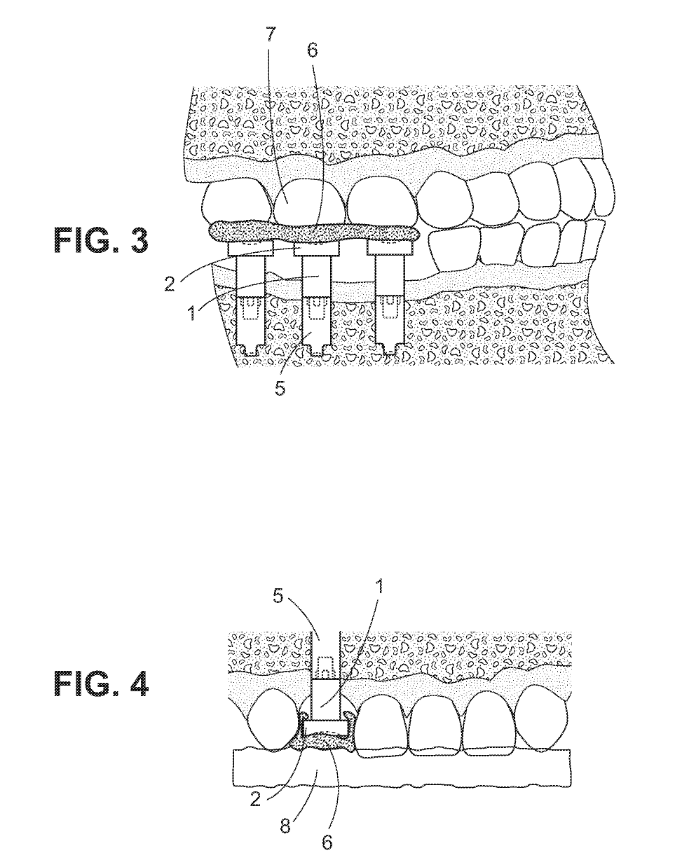

FIG. 3 shows use of the exemplary embodiment of the inventive device in obtaining an incisal or occlusal bite record, such as a bite registration of a patient's teeth. In the embodiment shown in FIG. 3, the patient may need replacement of three (3) teeth. Each tooth being replaced may be removed from the mouth and a dental implant 5 may be surgically inserted into the patient's bone tissue. The inventive device may be placed onto the dental implant 5. In some embodiments, the inventive device, particularly where the device has a shape that provides directional orientation, such as, for example, an asymmetrical shape, the device may be placed onto the implant 5 in a directional orientation corresponding to that of the removed teeth, which may allow a dentist to subsequently index and identify the orientation of a patient's bite registration and provide an anatomical guide for precise mounting of prosthetics. All of this may be performed by the dentist at a patient's initial dental impression appointment following oral surgery for inserting the implants 5 into biologic tissue. In particular, the device may be press-fit into an orifice at the external terminal end of the dental implant 5. Preferably, the post portion 3 of the device may be completely inserted into an orifice at the external terminal end of the dental implant 5. To obtain a bite registration of the patient, a device (e.g., coping) of the present invention having an appropriate size and height may be selected. The height of the device may also be adjusted by removal of a small portion of the external terminal end of the head portion 2 to configure and adjust the height of the device to a patient's anatomical bite configuration and size. As can be seen in FIG. 3, the device may be attached to the implants 5 and adjusted to have a substantially similar height as adjacent natural teeth or prosthesis.

Once the size and heights of the devices have been adjusted to correspond or substantially correspond to a patient's anatomical bite configuration and size, a registration material 6 may be applied between the upper and lower teeth, when the teeth are closed together as shown in FIG. 3, at or about the implant site for obtaining a bite registration of the patient. For example, when the implants 5 are placed into the lower dental arch of the patient as shown in FIG. 3, the registration material 6 is applied between the head portions 2 of the implants 5 and the bite surface on the upper teeth opposing the implants 5. If the implants 5 are placed into the upper dental arch of the patient (not shown), the registration material 6 may be applied between the head portion 2 of the implant 5 and the opposing bite surface of the lower teeth. The bite record obtained by the registration material 6 may include imprints of the inventive device that can be used by a dentist to identify the position and orientation of the implants 5. Alternatively, a rigid acrylic or composite resin could be directly bonded to the inventive device.

The registration material 6 may comprise any material that will set quickly, have little or no distortion, and accurately capture the detail of the opposing surfaces. It should not be so hard that it damages the stone casts when used during the mounting procedure. For example, the registration material 6 may be a malleable solid, a rapid curing material in the form of a gel, paste and/or viscous fluid that subsequently cures or hardens to form a rigid material. In particular, the registration material 6 may be placed between implants 5 and the opposing bite surface on the upper or lower teeth (depending on where the implants are located). The patient may bite on the registration material 6 and apply light pressure to mold the registration material 6 to form an imprint of the inventive device or coping surface and opposing teeth 7.

Alternatively, the registration material 6 may be a wax, acrylic, composite, polyether, polyvinyl, or addition silicones that quickly harden or cure upon application. In some embodiments, the registration material 6 may be a syringeable flow-on material. For example, the registration material 6 may be applied between the inventive device (e.g., implant copings) and the corresponding upper or lower teeth. The patient is guided to close into either a centric or habitual biting position until the material has cured or hardened. It is then removed from the mouth.

In an alternative embodiment, the registration material 6 may be bonded directly to the device or copings, with adequate parallelism. The bonded registration material 6 and device or copings may be subsequently removed as one piece. If this registration seats perfectly on the working model, it verifies the accuracy of the original impressions and working cast.

The registration material 6 may comprise any suitable medium for obtaining a dental bite registration, such as, for example, wax, self-curing polymers, light-curing polymers, fast-curing polymers, thermoplastic materials, silicones, acrylics, injectable polyvinyls, resins, polyolefins, etc. Suitable registration materials 6 may include addition-cured silicone, vinyl polysiloxane, methylhydrogen siloxane, polyvinyl chloride, acrylic resin, hydrophilic, biocompatible resin-modified glass ionomer cements, bite-registration wax. Examples of commercially available registration materials 6 include Bite-Registration Sheet Wax available from DeLar Corporation, Futar® Bite Registration Material available from Kettenbach LP, LuxaBite Registration Material available from DMG America, and G-Cem Resin Cement available from GC America Inc.

FIG. 4 shows an alternative use of an exemplary embodiment of the inventive device. The device may be attached to an implant 5 and used as a transfer component to index the position of the implant 5 along a model of a dental arch, such as, for example, a dental surgical guide 8. The dental surgical guide 8 has a shape corresponding to an impression of the patient's teeth prior to surgery. For example, the dental surgical guide 8 corresponds to an impression of the patient's teeth prior to removal of diseased teeth and insertion of dental implants 5. The device may be placed onto the dental implant 5, preferably press-fitted into an orifice located at the external terminal end of the dental implant 5. As shown in FIG. 4, the dental implant 5 may be surgically placed into the upper dental arch of a patient and the inventive device may be fitted onto an external terminal end of the implant. Preferably, the post portion 3 of the device is completely inserted into an orifice located at the external terminal end of the dental implant 5. The size and height of the device may be selected and adjusted in the same manner as discussed above with respect to FIG. 3, to provide clearance from the guide.

Once the size and heights of the devices have been adjusted to correspond or substantially correspond to a patient's anatomical bite configuration and size, a rigid, cured registration material 6 (e.g., GC Resin or light cured resin) may be applied to the head portion 2 of the inventive device, attaching it to a fully seated dental surgical guide. With the coping rigidly attached to the guide, an implant analog is attached, space created on the working model, and stone added to create a working model for provisional fabrication.

In another embodiment, the registration material 6 may be attached to the device to form one-piece bite registration. Such one-piece bite registrations allow a dentist to verify the implant position and accuracy of any working models of the patient's teeth. In some embodiments, the inventive device may be indexed to adjacent natural teeth and serve as a verification jig for assessing the relative position of the implants to the natural teeth remaining in the patients' mouth, and provide information regarding the patient's dentition for molding a working cast for the making of prosthetic teeth. In other embodiments, a plurality of the inventive devices or copings may be splinted together for assessing the relative position of the implants to each other and assess the accuracy of any working models of the patient's teeth. If an individual device or coping is used for a bite registration, the device may be marked by any suitable means (e.g., alcohol or permanent marker) to indicate the orientation of the device on any working models of the patient's teeth.

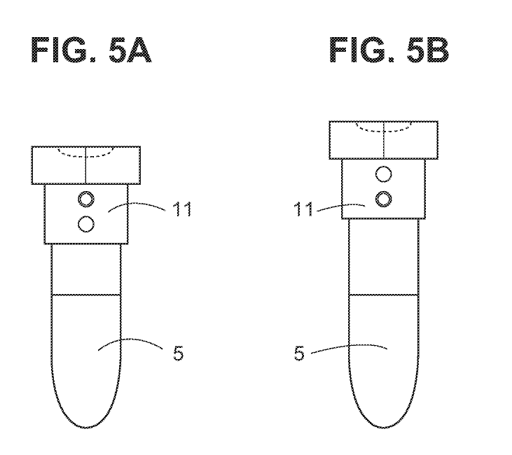

In an alternative embodiment of the invention, the height of the device may be adjustable by any suitable means. For example, as shown in FIGS. 5A and 5B, the body portion 1 of the device may comprise one or more (e.g., 2, 3, 4, or 5) of protrusions or slightly raised dimples for engaging one or more (e.g., 2, 3, 4, or 5) complementary cut-aways or depressions on an outer collar 11 connected to the head portion 2 of the device. The outer collar 11 may have a hollow, elongated shape for receiving the body portion 1 of the device therethrough. The outer collar 11 may have any suitable horizontal cross-sectional shape, such as a circle, oval, triangle, square, pentagon, hexagon, or any other regular or irregular shapes. In particular, the outer collar 11 has a shape corresponding to or complementary with the shape of the body portion 1. Preferably, the outer collar 11 has a circular horizontal cross-sectional shape. More preferably, the outer collar 11 has a substantially cylindrical or cylindrical shape. In some embodiments, the outer collar 11 may be co-axial with the body portion 1 of the device. The outer collar 11 may also be co-axial with the head portion 2 of the device.

In some embodiments, the outer collar 11 and the head portion 2 may comprise a single component of the device. Preferably, the outer collar 11 and the head portion 2 are integrally molded together. The protrusions or slightly raised dimples may be aligned along the height of the body portion 1. In some embodiments, the protrusions or slightly raised dimples may be spaced at regular intervals. Alternatively, the cut-aways or depressions on the outer collar 11 may be aligned along the height of the outer collar 11. Specifically, the cut-aways or depressions on the outer collar 11 may be spaced at regular intervals.

In one embodiment, to raise the height of the device, the protrusions or slightly raised dimples on the body portion of the device may be adjusted to engage one or more cut-aways or depressions on the outer collar 11 that are closer to the head portion 2. To reduce the height of device, the protrusions or slightly raised dimples on the body portion 1 of the device may be adjusted to engage one or more cut-aways or depressions on the outer collar 11 that are closer to the post portion 3. For example, as shown in FIGS. 5A and 5B, the outer collar 11 may comprise a least two (2) cut-aways or depressions arranged along the height of the outer collar 11, having a first cut-away or depression closer towards the head portion 2 and a second cut-away or depression closer towards the post portion 3. In an extended configuration, shown in FIG. 5A, a protrusion or slightly raised dimple on the body portion 1 may be engaged to, preferably reversibly engaged to, the first cut-away or depression to provide for a taller height. As shown in FIG. 5B, to reduce the height of the exemplary device, the protrusion or slightly raised dimple may be moved to engage, preferably reversibly engage, the second cut-away or depression to provide for a shorter height.

Alternatively, to raise the height of the device, the cut-away(s) or depression(s) on the outer collar 11 of the device may be adjusted to engage one or more protrusions or slightly raised dimples on the body portion 1 of the device that is further from the post portion 3. To reduce the height of the device, the cut-away(s) or depression(s) on the outer collar 11 may be adjusted to engage one or more protrusions or slightly raised dimples on the body portion 1 of the device that are closer to the post portion 3.

The device may be secured at the desired height by applying a resin to the device, particularly around the outer collar 11, before making a bite registration in the same manner as described above with respect to FIGS. 3 and 4.

The invention described and claimed herein is not to be limited in scope by the specific embodiments herein disclosed since these embodiments are intended as illustrations of several aspects of this invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

What is claimed:

1. A dental coping comprising:
a head portion having a shape configured to approximate an occlusal or incisal biting surface,
an elongated body extending from said head portion, and
a post portion extending from the end of said body opposite said head portion, said post portion configured to reversibly press-fit into a bore of a dental implant for receiving a dental abutment,
wherein said head portion and said elongated body together are configured to approximate the height of a tooth from a patient, such that when said coping is press-fitted onto said dental implant, a distance between said head portion and opposing bite surface from said patient approximates a combined distance of an anatomical occlusal or incisal distance of said patient and a thickness of a bite registration material.

2. The dental coping according to claim 1, wherein said elongated body has a substantially cylindrical shape.

3. The dental coping according to claim 1, wherein said post portion has a substantially hexagonal cross-section or a substantially cylindrical shape.

4. The dental coping according to claim 1, wherein said coping is formed from a plastic material.

5. The dental coping according to claim 1, wherein said coping is formed from a non-malleable plastic material.

6. The dental coping according to claim 1, wherein said post portion has a shape complementary to said bore, such that when said device is press-fitted onto said dental implant, said post portion substantially fills the bore.

7. The dental coping according to claim 1, wherein said coping is configured to have a reversibly adjustable height.

8. The dental coping according to claim 7, wherein said elongated body is configured to have a reversibly adjustable height.

9. A method for obtaining a bite registration of a patient having a dental implant for supporting a prosthesis, said method comprising:
(a) reversibly attaching a dental coping to said implant by pressing said coping into a bore of said implant for receiving a dental abutment, said coping comprising,
a head portion have a shape configured to approximate an occlusal or incisal biting surface, and
an elongated body extending from said head portion,
wherein said head portion and said elongated body together are configured to approximate the height of a tooth from a patient;
(b) applying a registration material to an occlusal or incisal space between said dental coping and opposing bite surface from said patient;
(c) causing said patient to bite on said registration material; and
(d) removing said registration material from said patient.

10. The method according to claim 9, wherein step (a) comprises adjusting a height of said dental coping such that when said device is attached onto said dental implant, a distance between said head portion and opposing bite surface from said patient approximates a combined distance of an anatomical occlusal or incisal distance of said patient and a thickness of a bite registration material.

11. The method according to claim 9, wherein said registration material is a wax.

12. The method according to claim 9, wherein step (c) comprises causing said patient to continuously bite on said registration material until said registration material hardens.

13. The method according to claim 12, wherein said registration material comprises a light-curing polymer or a self-curing polymer.

14. The method according to claim 13, wherein said registration material comprises an acrylic resin.

15. A method for indexing a dental implant of a patient comprising:
(a) reversibly attaching a dental coping to said implant by pressing said coping into a bore of said implant for receiving a dental abutment, said coping comprising,
a head portion have a shape configured to approximate an occlusal or incisal biting surface, and
an elongated body extending from said head portion,
wherein said head portion and said elongated body together are configured to approximate the height of a tooth from a patient;
(b) applying a registration material to said dental coping;
(c) aligning a dental surgical guide to said patient's teeth; and
(d) continuously applying a pressure against said dental surgical guard towards said registration material until said hardens; and
(e) removing said registration material from said patient.

16. The method according to claim 15, wherein step (a) comprises adjusting a height of said dental coping such that when said device is attached onto said dental implant, a distance between said head portion and opposing bite surface from said patient approximates an anatomical occlusal or incisal distance of said patient.

17. The method according to claim 15, wherein said registration material comprises a light-curing polymer or a self-curing polymer.

18. The method according to claim 17, wherein said registration material comprises an acrylic resin.
